(19) United States
(12) Patent Application Publication
(10) Pub. No.: US 2021/0213551 A1
(43) Pub. Date: Jul. 15, 2021

(54) RATCHET STRUCTURE

(71) Applicant: INFAR INDUSTRIAL CO., LTD., CHANG-HWA (TW)

(72) Inventor: Tai-Hung CHEN, CHANG-HWA (TW)

(21) Appl. No.: 17/035,688

(22) Filed: Sep. 29, 2020

Related U.S. Application Data
(63) Continuation-in-part of application No. 16/739,130, filed on Jan. 10, 2020, now abandoned.

(51) Int. Cl. B23F 1/06; B21K 1/30; B23Q 11/00

(52) U.S. Cl. CPC B23F 1/06; B23Q 11/0042; B21K 1/30

(57) ABSTRACT

A ratchet structure includes a body. The body is provided with a plurality of equally spaced ratchet teeth extending along the axial direction, and an annular groove is formed on the body to divide the body into a head portion and a body portion. The ratchet teeth are located on the body portion, and a predetermined groove is provided between the ratchet teeth and the annular groove. With the predetermined groove, when the milling cutter mills out the groove in the body portion and enters the predetermined groove, the waste chips connected to the annular groove bottom surface of the annular groove will be surely cut off, thereby solving the problem that it is difficult for the ratchet wheel to get rid of the waste chips.

This application is a continuation in part of U.S. patent application Ser. No. 16/739,130 which claims the benefit of the earlier filing date of Jan. 10, 2020.

### BACKGROUND

### Field of the Invention

The present invention relates to a hand tool, and more particularly to a ratchet structure for a hand tool.

### Related Prior Art

Referring to FIG. 1, a ratchet is installed in the head of a conventional ratchet wrench, and during the forming process of the ratchet, a preforming step is firstly performed to roughly form a cylindrical body 10, and then an annular-groove forming step is carried out. In this step, an annular groove 11 is milled along the circumferential surface of the body 10 and surrounds an axial direction X1 of the body 10, so that the annular groove 11 divides the body 10 into a head portion 12 and a body portion 13. Finally, a step of teeth forming is carried out to complete the manufacturing of the ratchet. In the step of teeth forming, a plurality of equally spaced grooves 14 are milled along the axial direction X1 on the surface of the body portion 13, and the milling direction starts from one end opposite the head portion 12 along the axial direction X1 toward the head portion 12. During the milling process, waste chips fall off from the body portion 13, however, when the milling cutter is milling to the annular groove 11, a small amount of waste chips often appear curled, and one end thereof is still connected to the body portion 13 and cannot fall off.

It is worth mentioning that the annular groove 11 is used to install a C-shaped buckle, and the waste chips that cannot fall off will make it difficult to install the C-shaped buckle in the annular groove 11. In view of this, it is indeed necessary to improve the shape of the ratchet to solve the problem that the waste chips can not fall off from the body portion 13 after milling process. The present invention has arisen to mitigate and/or obviate the afore-described disadvantages.

### SUMMARY

One objective of the present invention is to solve the problem that it is difficult to get rid of the waste chips after the ratchet is processed.

To achieve the above objective, a ratchet structure in accordance with the present invention comprises:

a body having a head portion, a body portion, and an annular groove formed between the head portion and the body portion and annularly formed in a circumferential surface of the body, wherein a direction extending from the head portion to the body portion is an axial direction, an outer surface of the body portion is provided with a plurality of ratchet teeth surrounding the body portion and extending along the axial direction, each of the ratchet teeth includes two opposite ends, namely, a bottom end and a top end, the bottom end is an end connected to the body portion and closer to the head portion than the top end, the bottom end is located a predetermined distance from the annular groove in the axial direction, each of the ratchet teeth includes a guide surface connected to the bottom end, the top end is connected to the guide surface, a distance between the top end and the annular groove along the axial direction is not equal to a distance between the bottom end and the annular groove along the axial direction, a groove is defined between every two neighboring ratchet teeth and has a groove bottom surface, a diameter of the body portion at the bottom end is defined as a first diameter, a diameter of the body portion at the groove bottom surface is defined as a second diameter, and the first diameter is smaller than the second diameter, so that the bottom end is a first distance from the groove bottom surface in a radial direction of the body portion, and the guide surface is located between the bottom end and the top end.

Preferably, each of the ratchet teeth includes a top end which is farther from the head portion than the bottom end, and the top end is a second distance from the groove bottom surface.

To achieve the above objective, a ratchet structure in accordance with another respect of the present invention comprises:

a body having a head portion, a body portion, and an annular groove formed between the head portion and the body portion and annularly formed in a circumferential surface of the body, wherein a direction extending from the head portion to the body portion is an axial direction, an outer surface of the body portion is provided with a plurality of ratchet teeth surrounding the body portion and extending along the axial direction, each of the ratchet teeth includes two opposite ends, namely, a bottom end and a top end, the bottom end is an end connected to the body portion and closer to the head portion than the top end, the bottom end is located a predetermined distance from the annular groove in the axial direction, each of the ratchet teeth includes a guide surface connected to the bottom end, the top end is connected to the guide surface, a distance between the top end and the annular groove along the axial direction is not equal to a distance between the bottom end and the annular groove along the axial direction, a groove is defined between every two neighboring ratchet teeth and has a groove bottom surface, a diameter of the body portion at the bottom end is defined as a first diameter, a diameter of the body portion at the groove bottom surface is defined as a second diameter, the first diameter is smaller than the second diameter, and the guide surface is located between the bottom end and the top end.

Preferably, each of the ratchet teeth includes a top end which is located farther from the head portion than the bottom end, and the top end is a second distance from the groove bottom surface in a radial direction of the body portion.

Preferably, the bottom end is closer to the head portion than the top end in the axial direction so that the guide surface between the bottom end and the top end is inclined with respect to the axial direction.

Preferably, a distance between the bottom end and the head portion is equal to the distance between the top end and the head portion in the axial direction so that the guide surface between the bottom end and the top end is perpendicular to the axial direction.

Preferably, the bottom end is farther from the head portion than the top end in the axial direction so that the guide surface between the bottom end and the top end is inclined relative to the axial direction.

Since the top end and the bottom end are at different distances from the ring groove in the axial direction, besides, because the first diameter is smaller than the second diameter, the closer the position of the body portion on the guide surface to the head portion, the shorter the diameter of the body portion. During the machining process, the milling cutter cuts the grooves from the end away from the head portion along the axial direction. In the process of cutting the grooves, the produced waste chips will be curled and moved toward the head portion while being connected to the body portion. When the milling cutter passes the guide surface, due to the gradually shortening of the diameter of the body portion, the waste chips produced by the milling cutter and connected to the body portion will gradually become thinner, making the portion of the waste chips connecting the body portion unstable and easy to break. When the milling cutter passes through the bottom end in the axial direction, because the bottom end is a first distance from the groove bottom surface, the milling cutter will not touch the body portion any longer after passing the bottom end, and the waste chips will leave the body portion together with the milling cutter at the moment the milling cutter leaves the body portion, thereby achieving the effect of preventing the residue of waste chips.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a side view of a conventional ratchet structure;

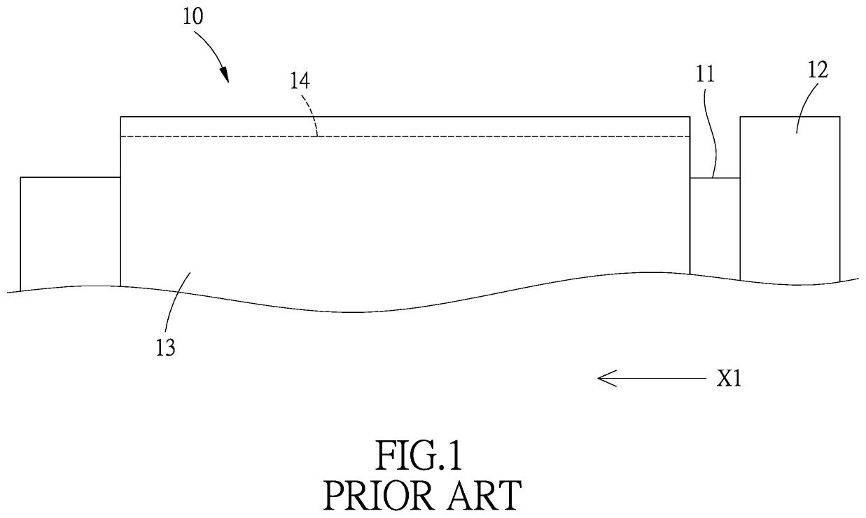

FIG. 2 is a side view of a first embodiment of the present invention;

FIG. 3 is a side view of the milling cutter processing state in the first embodiment of the present invention;

FIG. 4 is a side view of the first embodiment of the present invention showing that the milling cutter cuts the waste chips completely off the body through the first distance and the guide surface;

FIG. 5 is a side view of a second embodiment of the present invention;

FIG. 6 is a side view of a third embodiment of the present invention; and

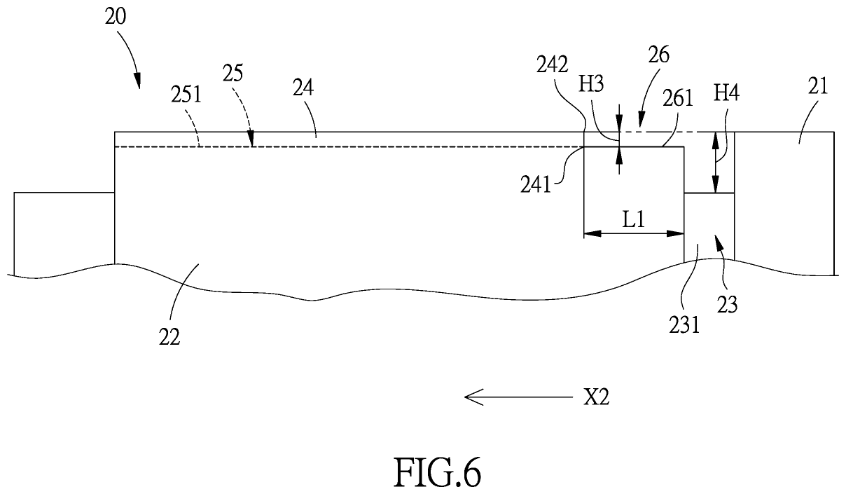

FIG. 7 is a side view of a fourth embodiment of the present invention.

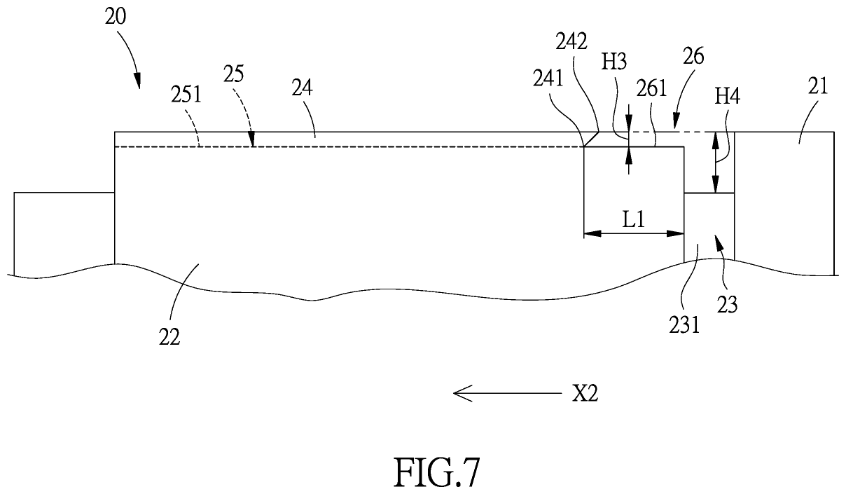

### DETAILED DESCRIPTION

The present invention will be clearer from the following description when viewed together with the accompanying drawings, which show, for purpose of illustrations only, the preferred embodiment in accordance with the present invention.

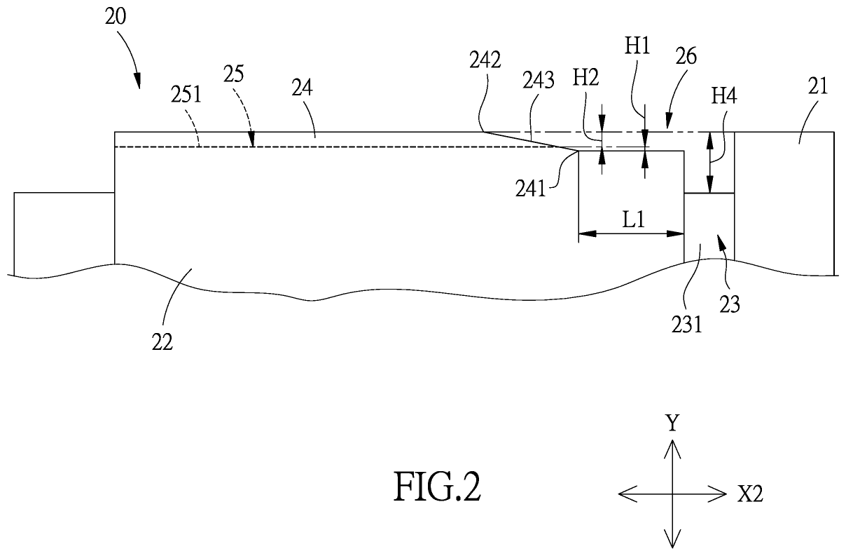

Referring to FIG. 2, a ratchet structure in accordance with the present invention comprises a body 20, which is substantially cylindrical, and the body 20 has an axial direction X2, and includes a head portion 21 and a body portion 22 connected to the head portion 21 along the axial direction X2. An annular groove 23 is formed between the head portion 21 and the body portion 22, and annularly formed in a circumferential surface of the body 20. An outer surface of the body portion 22 is provided with a plurality of ratchet teeth 24 extending along the axial direction X2, each of the ratchet teeth 24 includes two opposite ends along the axial direction X2, namely, a bottom end 241 and a top end 242. The bottom end 241 of each of the ratchet teeth 24 is an end close to the head portion 21 and connected to the body portion 22. The bottom end 241 of each of the ratchet teeth 24 is connected to a guide surface 243 which is inclined, and the guide surface 243 is connected to the top end 242, so that the guide surface 243 is connected between the bottom end 241 and the top end 242, and a distance between the top end 242 and the annular groove 23 along the axial direction X2 is not equal to a distance between the bottom end 241 and the annular groove 23 along the axial direction X2. The bottom end 241 is located a predetermined distance L1 from the annular groove 23. A groove 25 is defined between every two neighboring ratchet teeth 24, so that the body portion 22 includes a plurality of grooves 25 surrounding the body portion 22, and each of the grooves 25 has a groove bottom surface 251. A diameter of the body portion 22 at the bottom end 241 is defined as a first diameter 241′, a diameter of the body portion 22 at the groove bottom surface 251 is defined as a second diameter 251′, and the first diameter 241′ is smaller than the second diameter 251′, so that the bottom end 241 is a first distance H1 from the groove bottom surface 251 in the radial direction

Y of the body portion 22, and the top end 242 of each of the ratchet teeth 24 is a second distance H2 from the groove bottom surface 251 in the radial direction Y of the body portion 22. Preferably, the top end 242 is farther from the head portion 21 than the bottom end 241, so that the diameter of each of the ratchet teeth 24 gradually reduces as the guide surface 243 approaches the head 21. In the embodiment of FIG. 2, the distance between the top end 242 and the annular groove 23 along the axial direction X2 is greater than the distance between the bottom end 241 and the annular groove 23 along the axial direction X2. Since the top end 242 and the bottom end 241 are at different distances from the ring groove 23 in the axial direction X2, besides, because the first diameter 241′ is smaller than the second diameter 251′, the closer the position of the body portion 22 on the guide surface 243 to the head portion 21, the shorter the diameter of the body portion. During the machining process, the milling cutter cuts the grooves 25 from the end away from the head portion 21 along the axial direction X2. In the process of cutting the grooves 25, the produced waste chips will be curled and moved toward the head portion 21 while being connected to the body portion 22. When the milling cutter passes the guide surface 243, due to the gradually shortening of the diameter of the body portion 22, the waste chips produced by the milling cutter and connected to the body portion 22 will gradually become thinner, making the portion of the waste chips connecting the body portion 22 unstable and easy to break. When the milling cutter passes through the bottom end 241 in the axial direction X2, because the bottom end 241 is a first distance H1 from the groove bottom surface 251, the milling cutter will not touch the body portion 22 any longer after passing the bottom end 241, and the waste chips will leave the body portion 22 together with the milling cutter at the moment the milling cutter leaves the body portion 22, thereby achieving the effect of preventing the residue of waste chips.

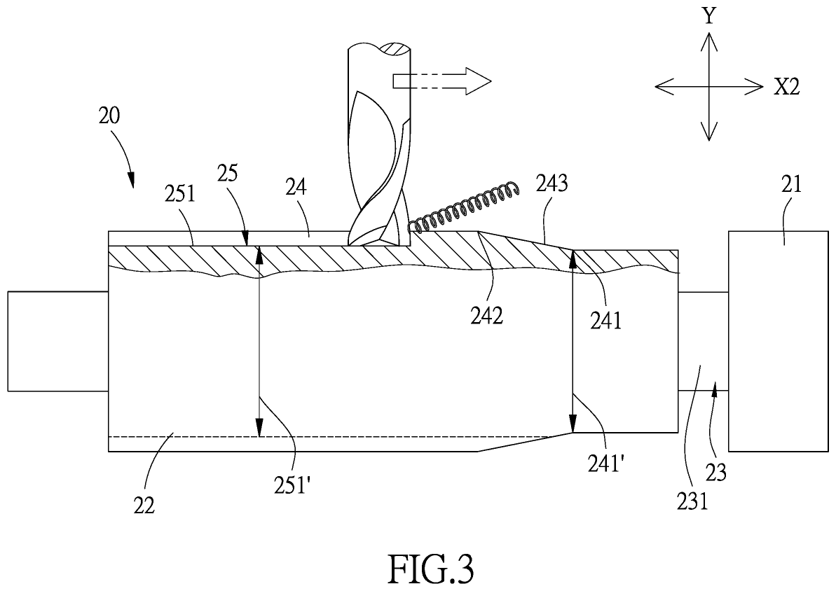

Referring to FIG. 3, in a second embodiment, the first diameter 241′ of the body portion 22 at the bottom end 241 is smaller than the second diameter 251′ of the body portion 22 at the groove bottom surface 251, and the distance between the top end 242 and the annular groove 23 along the axial direction X2 is greater than the distance between the bottom end 241 and the annular groove 23 along the axial direction X2.

Preferably, a predetermined groove 26 is provided between each of the ratchet teeth 24 and the annular groove 23 and recessed around the circumferential surface of the body 20, and the diameter of the body 20 at the annular groove 23 is smaller than the diameter of the body 20 at the predetermined groove 26.

In detail, the annular groove 23 has an annular groove bottom surface 231, the predetermined groove 26 has a predetermined groove bottom surface 261 which is a third distance H3 away from the top end 242 along the radial direction of the body 20. A fourth distance H4 is defined between the annular groove bottom surface 231 and the top end 242 along the radial direction of the body 20, and the third distance H3 is smaller than the fourth distance H4.

Please refer to FIGS. 2 and 3, in the first and second embodiments, the guide surface 243 is inclined with respect to the axial direction X2.

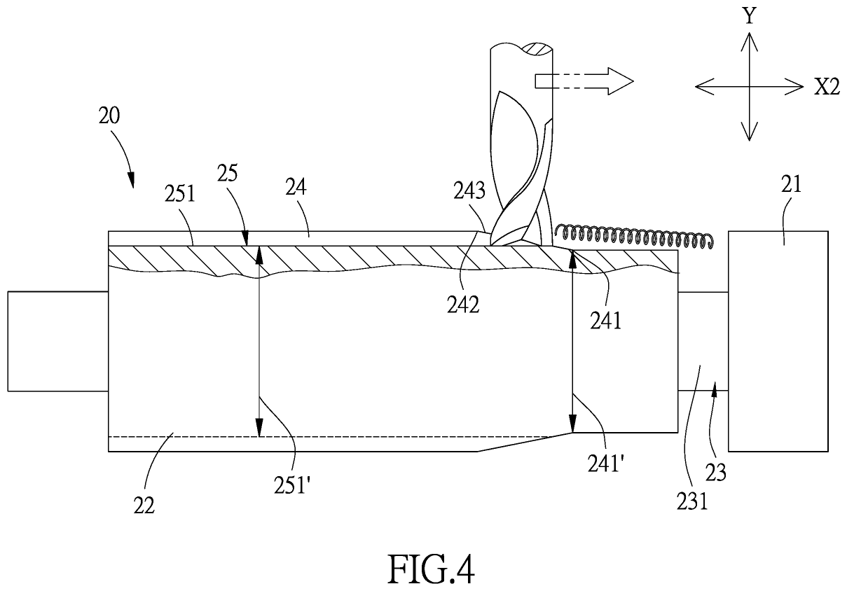

Please refer to FIG. 4, in a third embodiment, the distance between the bottom end 241 and the head portion 21 in the axial direction X2 is equal to the distance between the top end 242 and the head portion 21 in the axial direction X2, so that the guide surface 243 between the bottom end 241 and the top end 242 is perpendicular to the axial direction X2.

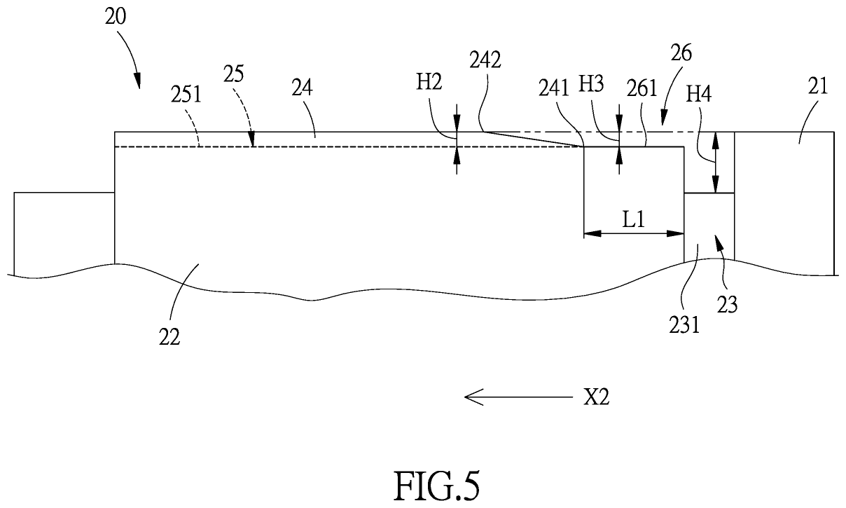

Please refer to FIG. 5, in a fourth embodiment, the bottom end 241 is farther from the head portion 21 than the top end 242, so that the guide surface 243 between the bottom end 241 and the top end 242 is inclined relative to the axial direction X2.

What mentioned above are the structural relations of the components of the different embodiments, and the usage of the present invention is explained as follows.

A method for forming the ratchet structure of the present invention comprises:

a pre-forming step: forming a preform of the body 20;

a step of forming the annular groove 23: milling out the annular groove 23 along the circumferential surface of the body 20, and defining, by the annular groove 23, the head portion 21 and the body portion 22;

a step of forming a predetermined groove 26: milling out the predetermined groove 26 around the circumferential surface of the body 20 and between the annular groove 23 and the body portion 22; and

a milling step: milling the groove 25 in the surface of the body portion 22 along the axial direction X2.

Since the bottom end 241 is located a predetermined distance L1 from the annular groove 23, when the milling cutter mills out the groove 25 in the body portion 22 and enters the predetermined groove 26, the waste chips connected to the annular groove bottom surface 231 of the annular groove will be surely cut off after the milling cutter enters the predetermined groove 26, thereby preventing waste chips from sticking to the body 20, and solving the problem that it is difficult for the ratchet wheel to get rid of the waste chips.

While we have shown and described various embodiments in accordance with the present invention, it is clear to those skilled in the art that further embodiments may be made without departing from the scope of the present invention.

What is claimed is:

1. A ratchet structure comprising:
a body having a head portion, a body portion, and an annular groove formed between the head portion and the body portion and annularly formed in a circumferential surface of the body, wherein a direction extending from the head portion to the body portion is an axial direction, an outer surface of the body portion is provided with a plurality of ratchet teeth surrounding the body portion and extending along the axial direction, each of the ratchet teeth includes two opposite ends, namely, a bottom end and a top end, the bottom end is an end connected to the body portion and closer to the head portion than the top end, the bottom end is located a predetermined distance from the annular groove in the axial direction, each of the ratchet teeth includes a guide surface connected to the bottom end, the top end is connected to the guide surface, a distance between the top end and the annular groove along the axial direction is not equal to a distance between the bottom end and the annular groove along the axial direction, a groove is defined between every two neighboring ratchet teeth and has a groove bottom surface, a diameter of the body portion at the bottom end is defined as a first diameter, a diameter of the body portion at the groove bottom surface is defined as a second diameter, and the first diameter is smaller than the second diameter, so that the bottom end is a first distance from the groove bottom surface in a radial direction of the body portion, and the guide surface is located between the bottom end and the top end.

2. The ratchet structure as claimed in claim 1, wherein each of the ratchet teeth includes a top end which is farther from the head portion than the bottom end, and the top end is a second distance from the groove bottom surface.

3. A ratchet structure comprising:
a body having a head portion, a body portion, and an annular groove formed between the head portion and the body portion and annularly formed in a circumferential surface of the body, wherein a direction extending from the head portion to the body portion is an axial direction, an outer surface of the body portion is provided with a plurality of ratchet teeth surrounding the body portion and extending along the axial direction, each of the ratchet teeth includes two opposite ends, namely, a bottom end and a top end, the bottom end is an end connected to the body portion and closer to the head portion than the top end, the bottom end is located a predetermined distance from the annular groove in the axial direction, each of the ratchet teeth includes a guide surface connected to the bottom end, the top end is connected to the guide surface, a distance between the top end and the annular groove along the axial direction is not equal to a distance between the bottom end and the annular groove along the axial direction, a groove is defined between every two neighboring ratchet teeth and has a groove bottom surface, a diameter of the body portion at the bottom end is defined as a first diameter, a diameter of the body portion at the groove bottom surface is defined as a second diameter, the first diameter is smaller than the second diameter, and the guide surface is located between the bottom end and the top end.

4. The ratchet structure as claimed in claim 3, wherein each of the ratchet teeth includes a top end which is located farther from the head portion than the bottom end, and the top end is a second distance from the groove bottom surface in a radial direction of the body portion.

5. The ratchet structure as claimed in claim 4, wherein the bottom end is closer to the head portion than the top end in the axial direction so that the guide surface between the bottom end and the top end is inclined with respect to the axial direction.

6. The ratchet structure as claimed in claim 4, wherein a distance between the bottom end and the head portion is equal to the distance between the top end and the head portion in the axial direction so that the guide surface between the bottom end and the top end is perpendicular to the axial direction.

7. The ratchet structure as claimed in claim 4, wherein the bottom end is farther from the head portion than the top end in the axial direction so that the guide surface between the bottom end and the top end is inclined relative to the axial direction.
